(19) United States
(12) Patent Application Publication
(10) Pub. No.: US 2016/0198882 A1
(43) Pub. Date: Jul. 14, 2016

(54) Bowl of a Cooking Container Comprising a Mounting Provided with an Electric Device

(71) Applicant: SEB S.A., Ecully (FR)

(72) Inventor: Benoît Linglin, Saint Martin Bellevue (FR)

(21) Appl. No.: 14/916,827

(22) PCT Filed: Sep. 3, 2014
(86) PCT No.: PCT/FR2014/052174

§ 371 Date: Mar. 4, 2016

(30) Foreign Application Priority Data
Sep. 6, 2013 (FR) 1358550

(51) Int. Cl. A47J 27/00; A47J 37/10; A47J 36/02

(52) U.S. Cl. CPC A47J 27/002; A47J 36/02; A47J 37/105

(57) ABSTRACT

A cooking container has a bowl including a bottom, a side wall and an electric device provided with at least one insulated conductive element. The conductive element extends from the bottom to the side wall. The conductive element is attached to a rigid mounting by deposition, such as by silk-screen printing, pad printing, thermal spraying, decalcomania or laser sintering. The mounting is separate from the bowl.

The present invention relates to a cooking container designed to be set on a hotplate, a burner, or the like for cooking food, in particular a skillet, a casserole, a pan, a Dutch oven, or a pressure cooker, more particularly a cooking container equipped with a bowl comprising an electric device.

Document EP0931495 discloses a cooking container comprising a bottom and a side wall, an electric device having a temperature sensor and two conductive wires integrated in the bottom and connected to an electronic circuit for processing the quantity measured and displaying the temperature. The temperature sensor and the two conductive wires are arranged in a channel formed in the bottom of the cooking container, a perforated plate being fastened onto the bottom by cold pressing. The temperature sensor is thus positioned between the perforated plate and the bottom.

Producing such a cooking container requires profound rethinking of the processes for manufacturing a standard cooking container without a temperature sensor. In order to prepare the container properly for the integration of this electric device, additional steps must be added to the process. Furthermore, the increased costs associated with the additional parts are significant.

Document WO 2013/007953 discloses a cooking container comprising a bowl having a bottom, a side wall, and an electric device comprising a run-around coil, said coil being arranged on the bowl and extending from the bottom to the side wall. The coil is attached to the bowl by deposition, in particular by silk-screen printing.

Producing such a cooking container requires that the bowl be reworked. Because the bowl is a large part, this complicates the manufacturing process.

The object of the present invention is to remedy the aforementioned disadvantages and to propose a cooking container equipped with an electric device that is simple in design and economically implemented.

Another object of the invention is to propose a cooking container equipped with an electric device that functions reliably, consistently, and for a long time.

These objects are achieved with a cooking container comprising a bowl having a bottom, a side wall, and an electric device equipped with at least one electrically insulated conductive element, said conductive element extending from the bottom to the side wall, characterized in that said conductive element is attached to a rigid mounting by deposition, in particular by silk-screen printing, pad printing, thermal spraying, decalcomania, or laser sintering, said mounting being separate from the bowl.

The electric device is thus composed of sturdy parts with good heat resistance in order to ensure long-term functionality.

“The conductive element is attached to a rigid mounting by deposition” is understood to mean that the conductive element is not intrinsically rigid until it is deposited on and secured to the rigid mounting. The conductive element advantageously comprises a metal powder and is attached to the mounting by means of a thermal process. In a still more advantageous manner, the metal powder can be combined with a binder to form a viscous liquid, thus facilitating the deposition thereof. In a variant, the powder is combined with a binder to form a track arranged on a temporary mounting before being deposited on the rigid mounting.

The conductive element is preferably surrounded by an insulating layer formed by depositing a material resistant to a temperature greater than 350° C., in particular a glass, ceramic, or enamel frit.

This arrangement makes it possible to obtain an electric device that withstands high temperatures and chemical abrasion by detergents during washing, in particular in a dishwasher. Furthermore, the type of process for manufacturing the insulation layer can be of the same type as the process for manufacturing the conductive element.

The mounting advantageously has a perforation provided with an angled peripheral lip embedded in the material of the bowl.

With this arrangement, the mounting can be attached to the bottom without an added piece and thus very inexpensively. Furthermore, such an attachment is long-lasting and very compact.

The angled peripheral lip is advantageously embedded in the bottom by means of a crimping operation.

With this arrangement, it is possible to attach the mounting to the bottom by an extremely economical operation. Furthermore, this crimping operation can be carried out at the end of the bowl manufacturing process. The bowl can thus receive the electric device at the last possible moment.

The mounting is preferably made of a non-ferromagnetic material, in particular austenitic stainless steel.

When the cooking container is used with an induction heating medium, this arrangement makes it possible to obtain a mounting that will not couple with the induction heating medium and will therefore not heat up.

The bowl advantageously comprises a receptacle for the mounting, making it possible to obtain a flat bottom surface.

This arrangement makes it possible for the surface of the bottom to cooperate correctly with a heating medium having a flat bearing surface.

The electric device advantageously comprises a sensor and/or a run-around coil designed to cooperate with an induction heating medium.

This arrangement makes it possible to optimize the manufacturing cost by using the same mounting for an electric device comprising one or two different functions, in particular a measurement function and a power supply function.

The sensor is preferably a temperature sensor that is electrically connected to the conductive elements.

This arrangement makes it possible to produce a temperature sensor sub-assembly in a very cost-effective manner.

The temperature sensor is advantageously a NTC or a thermocouple.

NTC is understood to mean a negative temperature coefficient thermistor.

The cooking container is preferably a skillet, a casserole, a pan, a Dutch oven, or a pressure cooker. For cooking food, the cooking container is designed to be set on a hotplate that is separate from the cooking container.

The invention also relates to a technique for manufacturing a bowl of a cooking container said bowl being formed from at least one metal layer and being adapted for receiving food, said technique having a step of giving the bowl a hollow shape such that it then has a bottom and a side wall that extends peripherally from the bottom, characterized in that after the step of forming a hollow shape, a rigid mounting is attached to the bowl, the mounting comprising an electric device having a conductive element attached to the rigid mounting by deposition, in particular by silk screen printing, pad printing, thermal spraying, decalcomania, or laser sintering.

The mounting equipped with the electric device can thus be manufactured as a sub-assembly separately from the process of manufacturing the bowl. Consequently, the process of manufacturing the bowl of the cooking container is close to the process of manufacturing the bowl of a standard cooking container.

The mounting is advantageously attached to the bowl by a crimping operation.

The mounting is preferably attached to the bowl after at least one of the following steps: a crimping step in which a perforated plate is pressed onto the bottom, a step in which the surface of the bowl is machined, in particular sanded, and/or a step in which a coating is deposited by silk screen printing or by spraying, a step in which the bowl is finished, in particular trimmed or polished.

The attachment of the mounting onto the bowl will thus be effected as late as possible in the process of producing the bowl, preferably after the last operation.

The invention will be more clearly understood by studying the exemplary embodiments, which are not limiting in any way and which are illustrated in the appended figures, wherein:

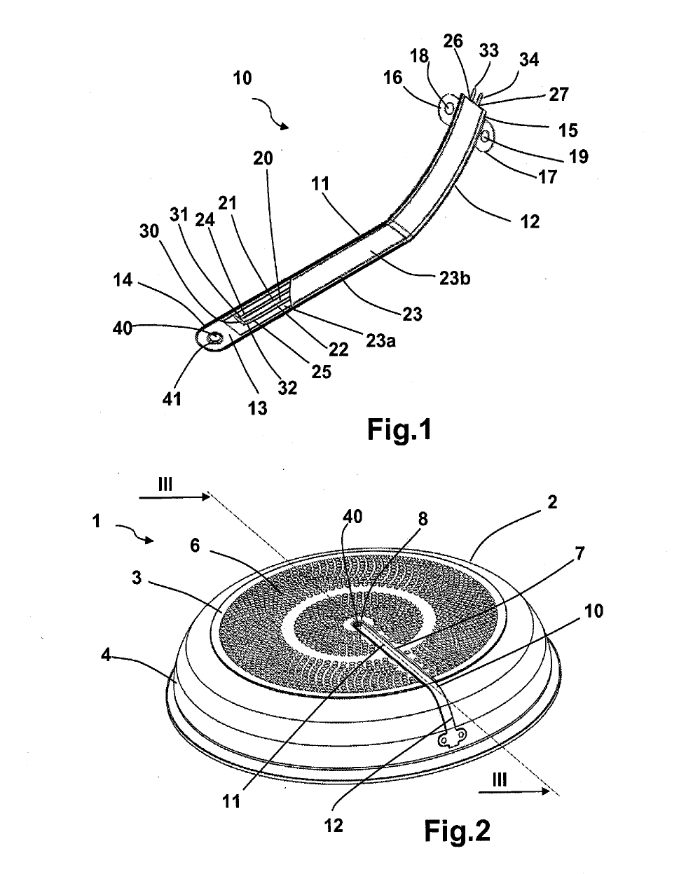

FIG. 1 shows a perspective view of a mounting according to a first special embodiment of the invention.

FIG. 2 shows a perspective view of a bowl of a cooking container equipped with the mounting of FIG. 1.

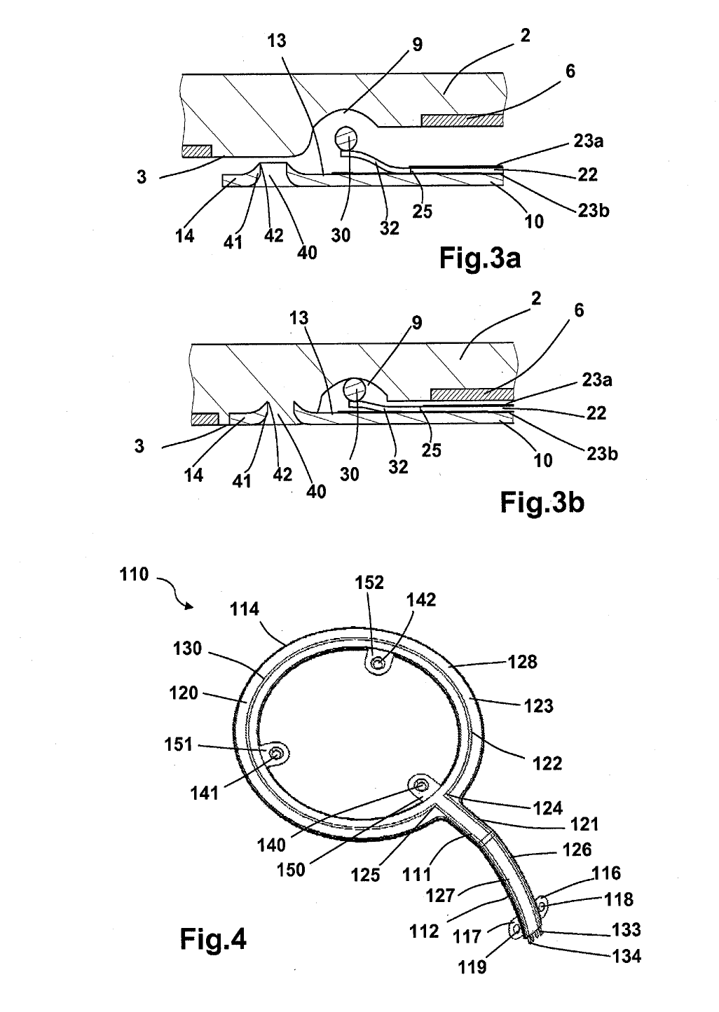

FIG. 3a shows a detailed cutaway view of the bowl of FIG. 2 along the line III-III, the mounting being illustrated in the non-crimped state.

FIG. 3b shows a detailed cutaway view of the bowl of FIG. 2 along the line III-III, the mounting being illustrated in the crimped state.

FIG. 4 shows a perspective view of a mounting according to a second special embodiment of the invention, in which the outer surface is visible.

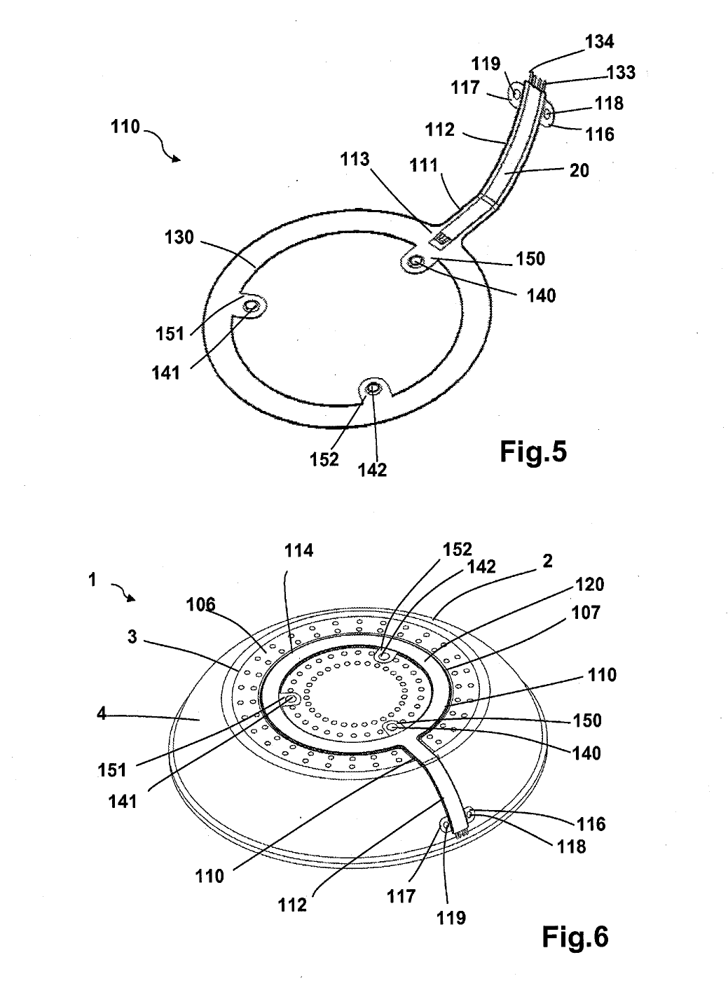

FIG. 5 shows a perspective view of a mounting of FIG. 4, in which the inner surface is visible.

FIG. 6 shows a perspective view of a bowl of a cooking container equipped with the mounting of FIG. 4.

According to a first embodiment shown in FIGS. 1 and 2, a cooking container 1 comprises a bowl 2 having a bottom 3 and a side wall 4. The bowl 2 comprises a rigid mounting 10, separate from the bowl 2, on which is arranged an electric temperature measuring device 20. A mounting 10 separate from the bowl 2 is understood to mean that the mounting 10 and the bowl 2 are two different parts. The mounting 10 is composed of a metal strip with an essentially uniform rectangular cross section with a width of 5 to 30 millimeters and with a thickness of 0.3 to 3 millimeters. The material of which the mounting 10 is made is advantageously stainless steel, preferably austenitic. The mounting 10 extends radially, essentially from the center of the bottom 3 to the side wall 4. The mounting 10 comprises a straight portion 11 matching the shape of the bottom 3 and an upwardly curved portion 12 matching the shape of the side wall 4.

The bowl 2 comprises a perforated plate 6 attached to the bottom 3 by pressing. The bottom 3 and the side wall 4 comprise a receptacle 7, also formed by pressing, preferably during the operation of crimping the perforated plate 6 into the bottom 3. The receptacle 7 has a shape adapted for receiving the mounting 10, specifically the straight portion 11 in the bottom 3 and the curved portion 12 in the side wall 4. The mounting 10 is positioned in the receptacle 7, in particular such that the bottom 3 has a flat surface intended to be set on the bearing surface of a heating medium.

The temperature measuring device 20 comprises a temperature sensor 30 and two conductive elements 21, 22 that are electrically insulated by an insulating layer 23. The conductive elements 21, 22 and the insulating layer 23 are attached to the mounting 10 by deposition, in particular by silk screen printing. Other techniques such as heat spraying, decalcomania, or laser sintering are conceivable. The conductive elements 21, 22 comprise two first ends 24, 25 electrically connected to two connection elements 31, 32 of the sensor 30 and two second ends 26, 27 connected to two rigid connectors 33, 34. Said rigid connectors 33, 34 are designed to be electrically connected to a control circuit arranged in, for example, a handle (not shown in the figures). The control circuit can comprise, for example, processing and display means and/or means of communication with a heating medium.

The mounting 10 equipped with the temperature measuring device 20 can be produced as a sub-assembly. The mounting 10 is cut from a strip and then shaped by pressing. The mounting 10 has an inner surface 13 on which is deposited a first part 23a of the insulating layer 23, for example a glass frit. The two conductive elements 21, 22, for example silver-based frits, are then deposited. After attaching the sensor 30 and the rigid connectors 33, 34, a second part 23b of the insulating layer 23 is deposited.

As can be discerned in FIGS. 1, 2, 3a and 3b, the mounting 10 comprises a first end 14 that is configured for comprising a round perforation 40 which has a conical peripheral lip 41 and a lip end 42. FIG. 3a shows the first end 14 of the mounting 10 thus configured, which end is arranged opposite the bottom 3 before attachment. The lip 41 of the perforation 40 forms a prominence oriented to the bottom 3. The perforated plate 6 comprises an opening 8 formed facing the temperature sensor 30 and the perforation 40. The bottom 3 comprises a cavity 9, which is arranged in the opening 8 for receiving the temperature sensor 30. FIG. 3b shows the first end 14 of the mounting 10 crimped into the bottom 3 by pressing. During the crimping, the lip 41 penetrates the material of the bottom 3, which is pushed into the perforation 40 for forming a means of anchoring the first end 14 in the bottom 3.

The temperature sensor 30 is arranged in the cavity 9. The two connection elements 31, 32 of the temperature sensor 30 connected to the two first ends 24, 25 of the conductive elements 21, 22 can be made from two flexible metal strips, which form means for keeping the temperature sensor 30 pressed against the bottom 3 once the first end 14 of the mounting 10 is crimped into the bottom.

The mounting 10 comprises a second end 15 that has two side projections 16, 17. Each projection 16, 17 comprises a perforation 18, 19 which can be configured identically to the perforation 40 for enabling the attachment of the second end 15 to the side wall 4 of the bowl 2.

FIGS. 4 through 6 show a mounting 110 according to a second embodiment. The mounting 110 has a ring-shaped part 114 arranged concentrically to the bottom 3, a straight part 111 that is lateral to the ring-shaped part 114 and which extends radially along the bottom 3, and a curved part 112 extending along the side wall 4. The mounting 110 comprises an outer surface 128, on which an electric energy recovery device 120 is arranged. The electric energy recovery device 120 is designed to cooperate with an induction heating medium and with a cooking container 1 compatible with such an induction heating medium. The device 120 comprises a coil 130 that generates electricity from a magnetic field produced by the induction heating medium when said coil 130 is positioned on the heating medium. The electricity generated by the coil 130 enables power to be supplied to an electric and/or electromechanical device arranged on the cooking container (not illustrated in the figures).

The device 120 comprises a conductive element 121 having an open loop 122 provided with two ends 124, 125 from which two side portions 126, 127 extend radially. The open loop 122 is arranged on the ring-shaped part 114 and the side portions 126, 127 are arranged on the straight part 111 and the curved part 112. The conductive element 121 is electrically insulated by an insulating layer 123. The conductive element 121 and the insulating layer 123 are attached to the mounting 110 by deposition. The straight portions 126, 127 comprise two ends connected to two rigid connectors 133, 134. The mounting 110 equipped with the energy recovery device 120 can be produced as a sub-assembly according to a process identical to the process for producing the mounting 10 equipped with the temperature measuring device 20.

As can be discerned in FIG. 5, the mounting 110 comprises an inner surface 113 on which the temperature measuring device 20 is arranged. The temperature measuring device 20 is arranged on the straight part 111 and on the curved part 112.

As can be discerned in FIG. 6, the bottom 3 comprises a perforated plate 106 attached by pressing. The perforated plate 106 is made of ferromagnetic stainless steel in order to ensure compatibility with the induction heating medium. The bottom 3 and the side wall 4 comprise a receptacle 107, also formed by pressing, preferably during the operation of crimping the perforated plate 106 onto the bottom 3. The receptacle 107 has a shape adapted for receiving the mounting 110.

The ring-shaped part 114 of the mounting 110 comprises three inner projections 150, 151, 152 arranged at a 120° angle, each comprising a perforation 140, 141, 142. The perforations 140, 141, 142 for securing the ring-shaped part 114 of the mounting 110 in the receptacle 107 by crimping are configured identically to the perforation 40.

At the end of the curved part 112, the mounting 110 comprises two side projections 116, 117. Each projection 116, 117 comprises a perforation 118, 119 for attaching the curved part 112 to the side wall 4 of the bowl 2, which can be configured identically to the perforation 40.

During operation, the user sets the bowl 2 of the cooking container 1 on the heating medium. In the first embodiment, the bowl 2 comprises the mounting 10 equipped with the temperature measuring device 20. The cooking container 1 can comprise a handle (not illustrated in the figures), which has a control circuit incorporating means for processing and for displaying the temperature. The user turns on the heating medium, which heats the bowl 2 and the temperature sensor 30, for example a variable resistance NTC. This variation is transmitted by the conductive elements 21, 22 to the control device, which calculates the temperature and indicates it to the user by display means. Once the preheating temperature is reached, the user puts the food to be cooked in the bowl 2. The control circuit can comprise means of communicating with the heating medium, in order to regulate the power supplied to the heating medium once a set temperature detected by the control circuit has been reached.

In the second embodiment, the mounting 110 comprises the electric energy recovery device 120. During operation, the user sets the bowl 2 on the induction heating medium. The user turns the induction heating medium on. The coil 130 positioned in the magnetic field generated by the induction heating medium then supplies a current, which is transmitted to the electric or electromagnetic device arranged on the cooking container 1.

The invention is obviously not limited in any way to the embodiments described and illustrated herein, which were merely provided as examples. Modifications are still possible, in particular with regard to the constitution of various elements or by substituting equivalent techniques, without exceeding the scope of protection of the invention in any way.

Hence in an alternative embodiment, the two side projections of the second end of the support each comprise a perforation that in each case cooperates with rivets for attaching a handle to the bowl. The second end is thus attached to the bowl by being clamped between the side wall and the handle.

1. A cooking container comprising a bowl having a bottom, a side wall, and an electric device equipped with at least one electrically insulated conductive element, said conductive element extending from the bottom to the side wall, wherein said conductive element is attached by deposition to a rigid mounting, said mounting being separate from the bowl.

2. The cooking container according to claim 1, wherein the conductive element is surrounded by an insulating layer formed by depositing a material resistant to a temperature greater than 350° C.

3. The cooking container according to claim 1, wherein the mounting has a perforation provided with an angled peripheral lip embedded in a material of the bowl.

4. The cooking container according to claim 3, wherein the angled peripheral lip is embedded in the bottom by a crimping operation.

5. The cooking container according to claim 1, wherein the mounting is made of a non-ferromagnetic material.

6. The cooking container according to claim 1, wherein the bowl comprises a receptacle for the mounting, such that a flat surface is formed on the bottom.

7. The cooking container according to claim 1, wherein the electric device comprises at least one of a sensor and a run-around coil designed to cooperate with an induction heating medium.

8. The cooking container according to claim 7, wherein the sensor is a temperature sensor that is electrically connected to the conductive elements.

9. The cooking container according to claim 8, wherein the temperature sensor is a NTC or a thermocouple.

10. The cooking container according to claim 1, wherein said container is a skillet, a casserole, a pan, a Dutch oven, or a pressure cooker.

11. A method for manufacturing a bowl of a cooking container, the bowl being formed from at least one metal layer and being adapted for receiving food, the method comprising forming the bowl with a hollow shape such that the bowl then has a bottom and a side wall that extends peripherally from the bottom, and after forming the hollow shape, attaching a rigid mounting to the bowl, said mounting comprising an electric device having a conductive element attached to the rigid mounting by deposition.

12. The method for manufacturing a bowl of a cooking container according to claim 11, wherein the mounting is attached to the bowl by a crimping operation.

13. The method for manufacturing a bowl of a cooking container according to claim 11, wherein the mounting is attached to the bowl after at least one of the following: crimping a perforated plate onto the bottom by pressing, machining the surface of the bowl, depositing a coating by silk screen printing or by spraying, and finishing the bowl by trimming or by polishing.

14. The cooking container of claim 1, wherein said deposition comprises silk screen printing, pad printing, thermal spraying, decalcomania, or laser sintering.

15. The cooking container of claim 2, wherein the material is glass, ceramic, or enamel frit.

16. The cooking container of claim 5, wherein the non-ferromagnetic material is austenitic stainless steel.

17. The method of claim 11, wherein said deposition comprises silk screen printing, pad printing, thermal spraying, decalcomania, or laser sintering.

18. The method of claim 13, wherein machining is sanding.
